(19) United States
(12) Patent Application Publication
(10) Pub. No.: US 2013/0155059 A1
(43) Pub. Date: Jun. 20, 2013

(54) SWITCHABLE TOUCH STEREOSCOPIC IMAGE DEVICE

(71) Applicants: Dongguan Masstop Liquid Crystal Display Co., Ltd, Dongguan City (CN); Wintek Corporation, Taichung City (TW)

(72) Inventors: Wen-Chun Wang, Taichung City (TW); Ching-Fu Hsu, Taichung City (TW); Ting-Yu Chang, Kaohsiung City (TW); Chong-Wei Li, Changhua County (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/712,928

(22) Filed: Dec. 12, 2012

(30) Foreign Application Priority Data
Dec. 16, 2011 (TW) 100146813

(51) Int. Cl. G06F 3/041

(52) U.S. Cl. CPC G06F 3/041
USPC 345/419

(57) ABSTRACT

A switchable touch stereoscopic image device includes a stereoscopic image generating module and a touch sensing module. The stereoscopic image generating module includes a first substrate, a second substrate, a light-path converting layer, driving electrodes and a common electrode. The first and second substrates are disposed corresponding to each other. The first substrate has a top surface. The second substrate has a top surface and a bottom surface facing the top surface of the first substrate. The light-path converting layer is disposed between the first and second substrates. The driving electrodes are disposed on the top surface of the first substrate. The common electrode is disposed on the bottom surface of the second substrate. The touch sensing module is disposed on a side of the second substrate of the stereoscopic image generating module and includes sensing electrodes disposed on a side of the top surface of the second substrate.

### BACKGROUND OF THE INVENTION

1. Field of the Invention

The present invention relates to a switchable touch stereoscopic image device, and more particularly, to a switchable touch stereoscopic image device having a touch sensing module integrated into a stereoscopic image generating module.

2. Description of the Prior Art

Touch input function and stereoscopic display effect are the main trend in current display development. Please refer to FIG. 1. FIG. 1 is a schematic diagram illustrating a conventional touch stereoscopic image device. The conventional touch stereoscopic image device is disposed on display surface of a display panel (not shown). The conventional touch stereoscopic image device 10 includes a stereoscopic image generating module 20 and a touch sensing module 30. The touch stereoscopic image device 20 includes a first substrate 21, a second substrate 22, a light-path converting layer 23, a common electrode 24 and a plurality of driving electrodes 25. The first substrate 21 and the second substrate 22 are disposed oppositely; the light-path converting layer 23 is disposed between the first substrate 21 and the second substrate 22; the common electrode 24 is disposed on the surface of the first substrate 21 facing the second substrate 22; and the driving electrodes 25 are disposed on the surface of the second substrate 22 facing the first substrate 21. The touch sensing module 30 is disposed above the stereoscopic image generating module 20. The touch sensing module 30 includes a third substrate 31, a fourth substrate 32, a first sensing electrode 33, a second sensing electrode 34 and a first optical adhesive 35. The third substrate 31 and the fourth substrate 32 are disposed oppositely; the first sensing electrode 33 is disposed on the surface of the third substrate 31 facing the fourth substrate 32, the second sensing electrode 34 is disposed on the surface of the fourth substrate 32 facing the third substrate 31; and the first optical adhesive 35 is used to bond the third substrate 31 and the fourth substrate 32. In addition, the conventional touch stereoscopic image device 10 further includes a second optical adhesive 36 for bonding the second substrate 22 of the stereoscopic image generating module 20 and the third substrate 31 of the touch sensing module 30.

The stereoscopic image generating module 20 and the touch sensing module 30 of the conventional touch stereoscopic image device 10 are stacked on each other and bonded by optical adhesives, and thus four pieces of substrates (including the first substrate 21, the second substrate 22, the third substrate 31 and the fourth substrate 32) and two layers of optical adhesives (including the first optical adhesive 35 and the second optical adhesive 36) are required. Consequently, the conventional touch stereoscopic image device 10 has thicker thickness and poor transmission rate, which does not meet slim body and high brightness requirements.

### SUMMARY OF THE INVENTION

It is one of the objectives of the present invention to provide a switchable touch stereoscopic image device with slim body and high transmission rate.

According to a preferred embodiment of the present invention, a switchable touch stereoscopic image device is provided. The switchable touch stereoscopic image device includes a stereoscopic image generating module and a touch sensing module. The stereoscopic image generating module includes a first substrate, a second substrate, a light-path converting layer, a plurality of driving electrodes and a common electrode. The second substrate and the first substrate are disposed corresponding to each other. The first substrate has a top surface. The second substrate has a top surface and a bottom surface facing the top surface of the first substrate. The light-path converting layer is disposed between the first substrate and the second substrate. The driving electrodes are disposed on the top surface of the first substrate. The common electrode is disposed on the bottom surface of the second substrate. The touch sensing module is disposed on a side of the second substrate of the stereoscopic image generating module and includes a plurality of sensing electrodes disposed on a side of the top surface of the second substrate.

According to another preferred embodiment of the present invention, a switchable touch stereoscopic image device is provided. The switchable touch stereoscopic image device includes a stereoscopic image generating module and a touch sensing module. The stereoscopic image generating module includes a first substrate, a second substrate, a light-path converting layer, a plurality of driving electrodes and a common electrode. The second substrate and the first substrate are disposed corresponding to each other. The first substrate has a top surface. The second substrate has a top surface and a bottom surface facing the top surface of the first substrate. The light-path converting layer is disposed between the first substrate and the second substrate. The driving electrodes are disposed on the top surface of the first substrate. The common electrode is disposed on the bottom surface of the second substrate. The touch sensing module is disposed on a side of the second substrate of the stereoscopic image generating module. The touch sensing module includes a third substrate, an elastic medium layer and a plurality of sensing electrodes. The third substrate faces the second substrate, and a bottom surface of the third substrate faces the top surface of the second substrate. The elastic medium layer is disposed between the second substrate and the third substrate, and the elastic medium layer is deformable by pressing. The sensing electrodes are disposed on the bottom surface of the third substrate. A gap between the sensing electrodes and the common electrode is changed due to a deformation of the elastic medium layer when the third substrate is pressed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional touch stereoscopic image device.

FIG. 2 is a schematic diagram illustrating a switchable touch stereoscopic image device according to a first preferred embodiment of the present invention.

FIG. 3 is a schematic diagram illustrating a switchable touch stereoscopic image device according to a second preferred embodiment of the present invention.

FIG. 4 is a schematic diagram illustrating a switchable touch stereoscopic image device according to a variant embodiment of the second preferred embodiment of the present invention.

FIG. 5 is a schematic diagram illustrating a switchable touch stereoscopic image device according to a third preferred embodiment of the present invention.

FIG. 6 is a schematic diagram illustrating a switchable touch stereoscopic image device according to a fourth preferred embodiment of the present invention.

FIG. 7 is a schematic diagram illustrating a switchable touch stereoscopic image device according to a variant embodiment of the fourth preferred embodiment of the present invention.

FIG. 8 is a schematic diagram illustrating a switchable touch stereoscopic image device according to another variant embodiment of the fourth preferred embodiment of the present invention.

FIG. 9 is block diagram of the switchable touch stereoscopic image device of the present invention.

FIG. 10 and FIG. 11 are schematic diagrams illustrating sensing electrodes according to other variant embodiments of the present invention.

### DETAILED DESCRIPTION

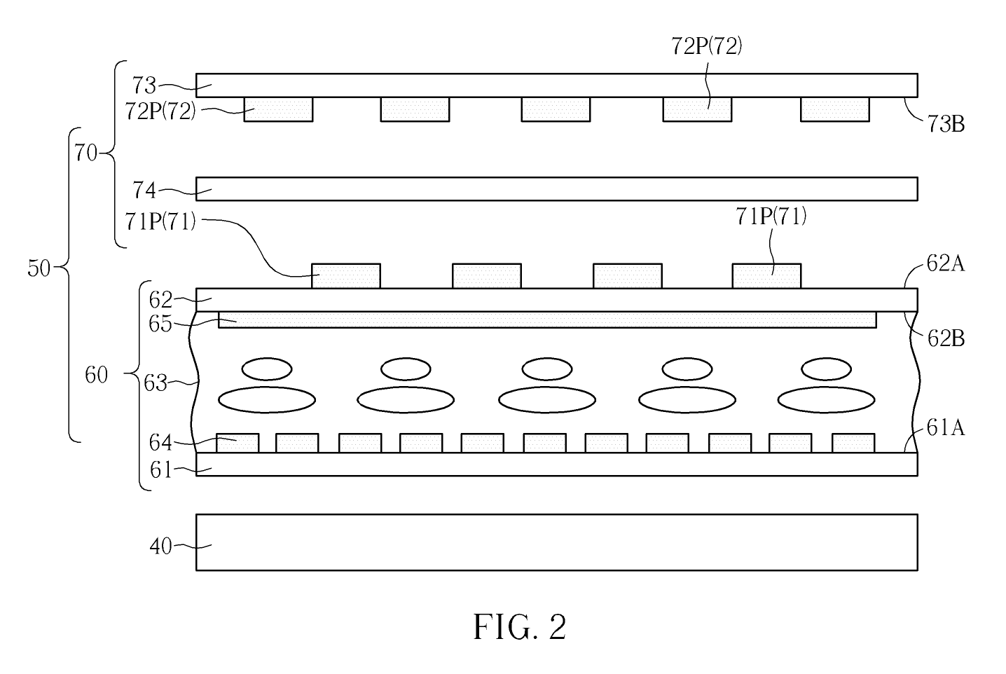

Please refer to FIG. 2. FIG. 2 is a schematic diagram illustrating a switchable touch stereoscopic image device according to a first preferred embodiment of the present invention. The switchable touch stereoscopic image device may be applied in a display panel 40, and provide the display panel 40 with two dimensional (2D) display effect or three dimensional (3D) display effect, and touch input function as well. The display panel 40 may be various types of display panels such as liquid crystal display (LCD) panel, organic light-emitting diode (OLED) display panel, field emission display (FED) panel, plasma display panel (PDP), electrophoretic display panel, etc. As shown in FIG. 2, the switchable touch stereoscopic image device 50 includes a stereoscopic image generating module 60 and a touch sensing module 70. The stereoscopic image generating module 60 includes a first substrate 61, a second substrate 62, a light-path converting layer 63, a plurality of driving electrodes 64 and a common electrode 65. The second substrate 62 is disposed corresponding to the first substrate 61, where a top surface 61A of the first substrate 61 faces a bottom surface 62B of the second substrate 62, and a top surface 62A of the second substrate 62 is opposite to the bottom surface 62B of the second substrate 62. In this embodiment, the light-path converting layer 63 may be a liquid crystal layer, but is not limited thereto. The light-path converting layer 63 is disposed between the first substrate 61 and the second substrate 62; the driving electrodes 64 are disposed on the top surface 61A of the first substrate 61; and the common electrode 65 is disposed on the bottom surface 62B of the second substrate 62. In this embodiment, the stereoscopic image generating module 60 may be a phase difference generating module. In a stereoscopic (3D) display mode, a voltage difference is applied between the driving electrodes 64 and the common electrode 65 and this voltage difference would drive liquid crystal molecules to rotate, which can alter the polarization direction of light passing through the stereoscopic image generating module 60. Accordingly, the left eye and the right eye of a user who wears a pair of polarization glasses can see a left eye image and a right eye image of different polarization directions, respectively, and thus perceive a stereoscopic display image. The stereoscopic image generating module 60 is not limited to a phase difference generating module. For example, the stereoscopic image generating module 60 may also be a liquid crystal lenticular lens module or a parallax barrier module, which also include a light-path converting layer that can be driven by the electrodes of the two substrates. The structure of liquid crystal lenticular lens module or parallax barrier module is well known, and thus is not redundantly illustrated. It is appreciated that the light-path converting layer of the parallax barrier module is not limited to a liquid crystal layer, and may be e.g. an electrochromic layer. In addition, when a liquid crystal lenticular lens module or a parallax barrier module is selected as the stereoscopic image generating module 60, it is unnecessary for the user to wear the polarization glasses in the stereoscopic display mode.

The touch sensing module 70 includes a plurality of sensing electrodes disposed on the side of the top surface 62A of the second substrate 62. In this embodiment, the sensing electrodes include a first sensing electrode 71 (e.g. X sensing electrode) disposed on the top surface 62A of the second substrate 62, and a second sensing electrode 72 (e.g. Y sensing electrode). The touch sensing module 70 further includes a third substrate 73 disposed corresponding to the second substrate 62, where a bottom surface 73B of the third substrate 73 faces the top surface 62A of the second substrate 62, and the second sensing electrode 72 is disposed on the bottom surface 73B of the third substrate 73. The first sensing electrode 71 includes a plurality of first sensing pads 71P, and the second sensing electrode 72 includes a plurality of second sensing pads 72P. In addition, the touch sensing module 70 may further include an optical adhesive 74 disposed between the second substrate 62 and the third substrate 73 for bonding the second substrate 62 and the third substrate 73. In this embodiment, the touch sensing module 70 is a capacitive touch sensing module such as a self capacitance type touch sensing module or mutual capacitance type touch sensing module. Also, the first sensing pads 71P and the second sensing pads 72P are preferably transparent sensing pads, and the shape of the first sensing pads 71P and the second sensing pads 72P may be, for instance, rectangle, rhombus, triangle or other shape.

In this embodiment, the touch sensing module 70 and the stereoscopic image generating module 60 are fabricated integratedly. Specifically, the first sensing electrode 71 of the touch sensing module 70 and the common electrode 65 of the stereoscopic image generating module 60 are formed on the top surface 62A and the bottom surface 62B of the second substrate 62, respectively. Consequently, one substrate and one optical adhesive are omitted in fabrication of the switchable touch stereoscopic image device 50, which can reduce thickness and improve transmission rate of the switchable touch stereoscopic image device 50. In addition, the common electrode 65 of the stereoscopic image generating module 60 can also function as a shielding electrode, which can avoid signal interference between the stereoscopic image generating module 60 and the touch sensing module 70.

The switchable touch stereoscopic image device is not limited by the aforementioned embodiment, and may have other different preferred embodiments. To simplify the description, the identical components in each of the following embodiments are marked with identical symbols. For making it easier to compare the difference between the embodiments, the following description will detail the dissimilarities among different embodiments and the identical features will not be redundantly described.

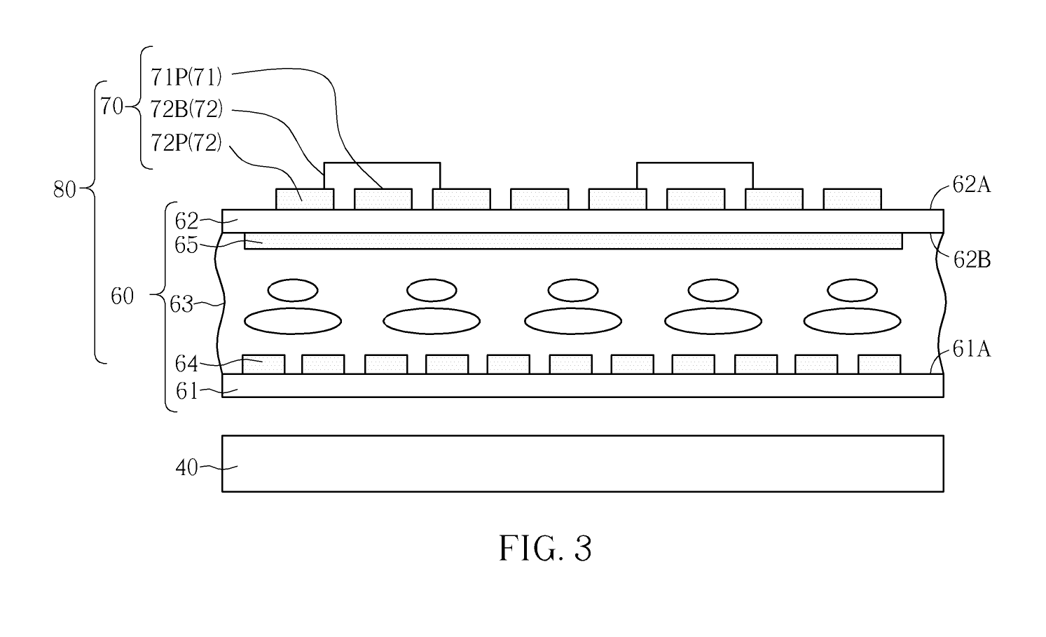

Please refer to FIG. 3. FIG. 3 is a schematic diagram illustrating a switchable touch stereoscopic image device according to a second preferred embodiment of the present invention. As shown in FIG. 3, in this embodiment, the touch sensing module 70 of the switchable touch stereoscopic image device 80 is also a capacitance touch sensing module. Different from the first preferred embodiment, the touch sensing module 70 of this embodiment does not include a third substrate, and the second sensing electrode 72 is disposed on the top surface 62A of the second substrate 62. Specifically, the first sensing electrode 71 includes a plurality of first sensing pads 71P, the second sensing electrode 72 includes a plurality of second sensing pads 72P, and the first sensing pads 71P and the second sensing pads 72P are both disposed on the top surface 62A of the second substrate 62. In this embodiment, the first sensing pads 71P and the second sensing pads 72P are disposed coplanarly, and the first sensing pads 71P and the second sensing pads 72P may be the same conductive pattern, e.g. the same transparent conductive pattern, but not limited thereto. In addition, two adjacent second sensing pads 72P are electrically connected through a bridge electrode 72B such as a transparent bridge electrode. Furthermore, a passivation layer (not shown) may cover the first sensing pads 71P and the second sensing pads 72P for protecting the first sensing pads 71P and the second sensing pads 72P. In this embodiment, two substrates and one optical adhesive are omitted in fabrication of the switchable touch stereoscopic image device 80, which can further reduce thickness and improve transmission rate of the switchable touch stereoscopic image device 80.

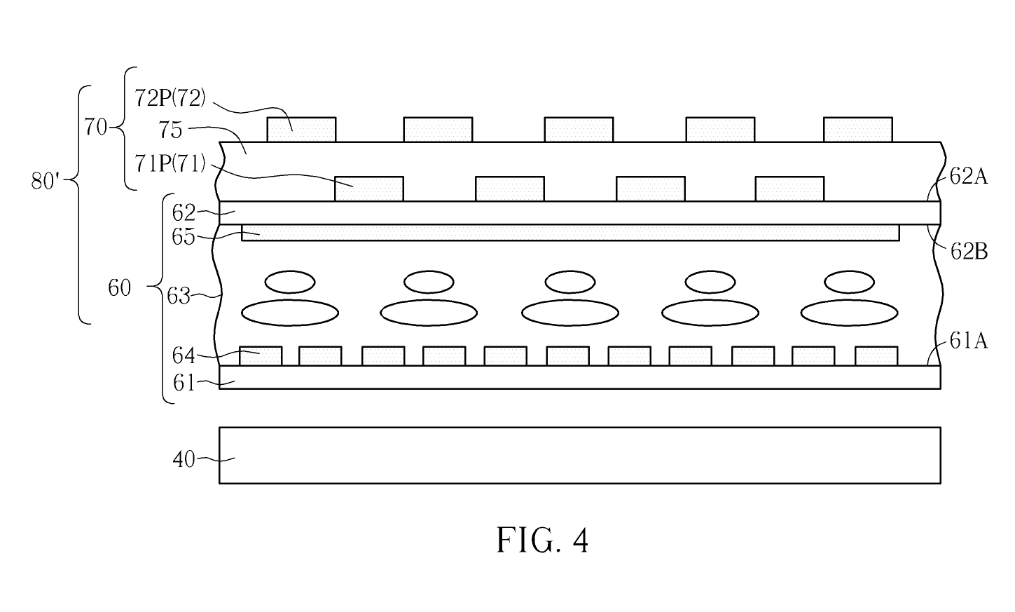

Please refer to FIG. 4. FIG. 4 is a schematic diagram illustrating a switchable touch stereoscopic image device according to a variant embodiment of the second preferred embodiment of the present invention. As shown in FIG. 4, different from the second preferred embodiment, in this variant embodiment, the first sensing pads 71P and the second sensing pads 72P of the touch sensing module 70 of the switchable touch stereoscopic image device 80′ are disposed incoplanarly. For example, the first sensing pads 71P and the second sensing pads 72P may be different conductive patterns, and the second sensing pads 72P may be disposed over the first sensing pads 71P, and insulated by an insulating layer 75 disposed therebetween. In addition, a passivation layer (not shown) may cover the second sensing pads 72P for protecting the first sensing pads 71P and the second sensing pads 72P. In this variant embodiment, two substrates and one optical adhesive are omitted in fabrication of the switchable touch stereoscopic image device 80′, which can further reduce thickness and improve transmission rate of the switchable touch stereoscopic image device 80′.

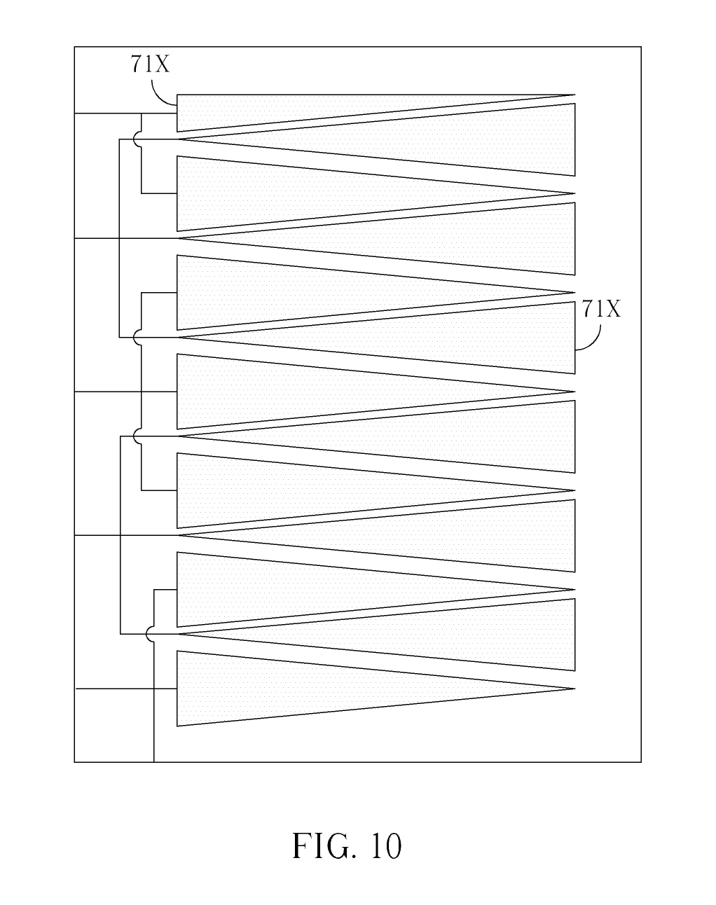

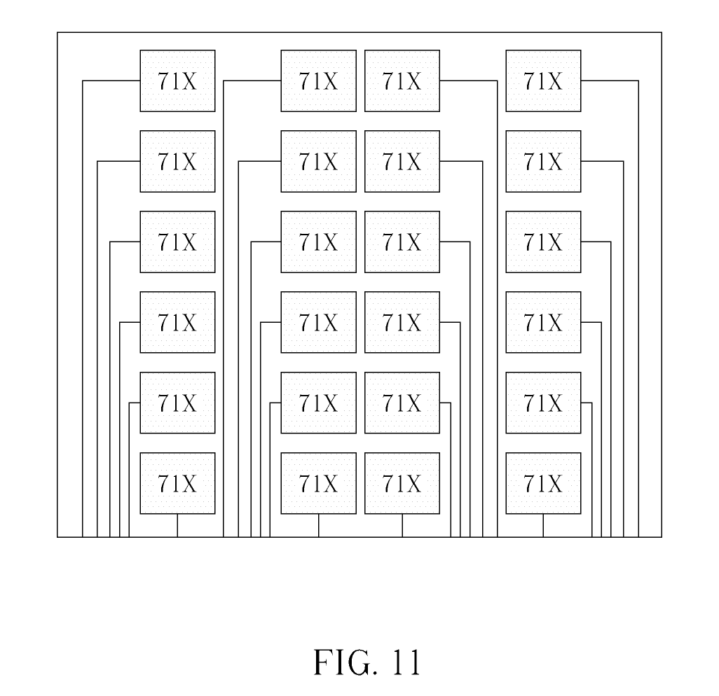

It is appreciated that in the aforementioned embodiments, the first sensing electrode and the second sensing electrode are exemplarily illustrated, but not limited thereto. The sensing electrodes of the present invention may be single-layered sensing electrodes in any forms. Please refer to FIG. 10 and FIG. 11. FIG. 10 and FIG. 11 are schematic diagrams illustrating sensing electrodes according to other variant embodiments of the present invention. As shown in FIG. 10, in this variant embodiment, the sensing electrodes are single-layered sensing electrodes including a plurality of sensing electrodes 71X having a triangle shape. As shown in FIG. 11, in this variant embodiment, the sensing electrodes are single-layered sensing electrodes including a plurality of sensing electrodes 71X having a rectangle shape. The sensing electrodes 71X shown in FIG. 10 or FIG. 11 may be the same conductive pattern or different conductive patterns.

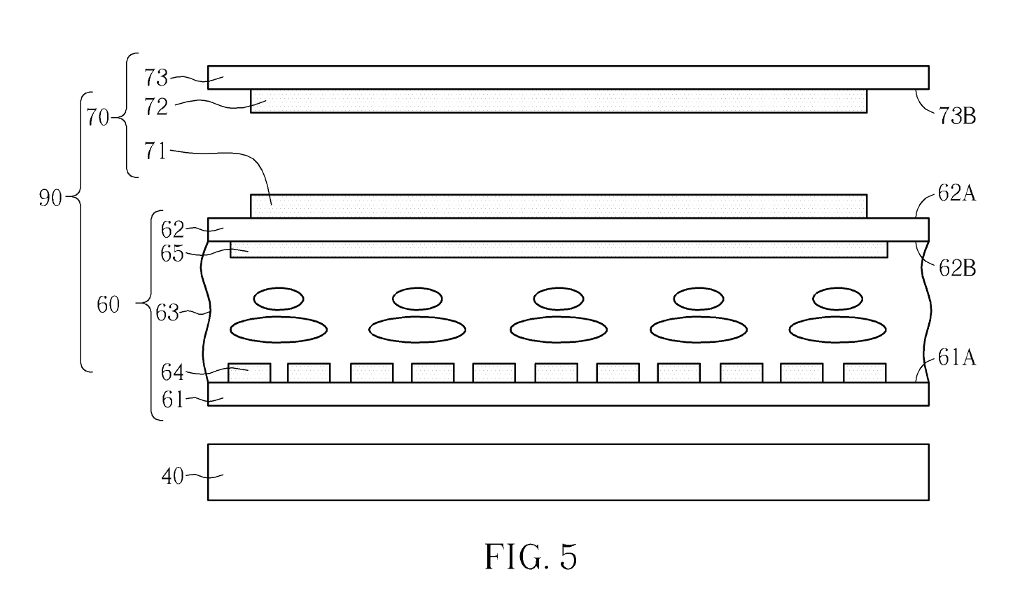

Please refer to FIG. 5. FIG. 5 is a schematic diagram illustrating a switchable touch stereoscopic image device according to a third preferred embodiment of the present invention. As shown in FIG. 5, in this embodiment, the touch sensing module 70 of the switchable touch stereoscopic image device 90 is a resistive type touch sensing module, and the first sensing electrode 71 disposed on the top surface 62A of the second substrate 62 and the second sensing electrode 72 disposed on the bottom surface 73B of the third substrate 73 are respectively a planar electrode. In this embodiment, one substrate and one optical adhesive are omitted in fabrication of the switchable touch stereoscopic image device 90, which can reduce thickness and improve transmission rate of the switchable touch stereoscopic image device 90.

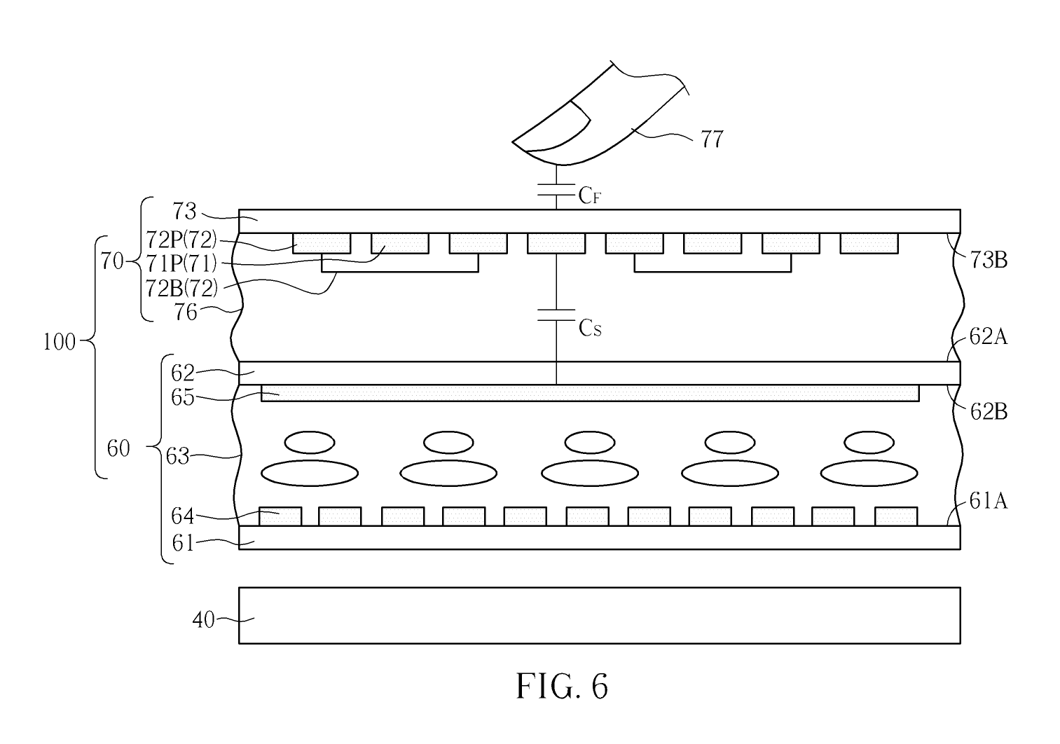

Please refer to FIG. 6. FIG. 6 is a schematic diagram illustrating a switchable touch stereoscopic image device according to a fourth preferred embodiment of the present invention. As shown in FIG. 6, the switchable touch stereoscopic image device 100 includes a stereoscopic image generating module 60 and a touch sensing module 70. The stereoscopic image generating module 60 includes a first substrate 61, a second substrate 62, a light-path converting layer 63, a plurality of driving electrodes 64 and a common electrode 65. The second substrate 62 is disposed corresponding to the first substrate 61, where a top surface 61A of the first substrate 61 faces a bottom surface 62B of the second substrate 62, and a top surface 62A of the second substrate 62 is opposite to the bottom surface 62B of the second substrate 62. In this embodiment, the light-path converting layer 63 is a liquid crystal layer, but not limited thereto. The light-path converting layer 63 is disposed between the first substrate 61 and the second substrate 62; the driving electrodes 64 are disposed on the top surface 61A of the first substrate 61; and the common electrode 65 is disposed on the bottom surface 62B of the second substrate 62. The touch sensing module 70 includes a third substrate 73, sensing electrodes including a first sensing electrode 71 (e.g. X sensing electrode) and a second sensing electrode 72 (e.g. Y sensing electrode) disposed on the bottom surface 73B of the third substrate 73, and an elastic medium layer 76. The third substrate 73 is disposed corresponding to the second substrate 62, and the bottom surface 73B of the third substrate 73 faces the top surface 62A of the second substrate 62. The elastic medium layer 76 is disposed between the second substrate 62 and the third substrate 73, and the elastic medium layer 76 is deformable by pressing. The elastic medium layer 76 may be, but is not limited to, a gaseous medium layer such as air layer, or other elastic medium layer such as liquid crystal layer, silicon oxide layer, or photoresist layer, etc. The elastic medium layer 76 is not limited to be a planar medium layer, but may also be a plurality of spacers disposed between the second substrate 62 and the third substrate 73 instead. The spacers may be e.g. silicon oxide spacers or photoresist spacers, but not limited thereto. The first sensing electrode 71 and the second sensing electrode 72 are both disposed on the bottom surface 73B of the third substrate 73. The first sensing electrode 71 includes a plurality of first sensing pads 71P, and the second sensing electrode 72 includes a plurality of second sensing pads 72P. In this embodiment, the first sensing pads 71P and the second sensing pads 72P are disposed coplanarly, and the first sensing pads 71P and the second sensing pads 72P may be the same conductive pattern, but not limited thereto. In addition, two adjacent second sensing pads 72P are electrically connected through a bridge electrode 72B such as a transparent bridge electrode.

In this embodiment, the touch sensing module 70 is a capacitance type touch sensing module such as a self capacitance type touch sensing module or mutual capacitance type touch sensing module. By virtue of the elastic medium layer 76 and the common electrode 65 of the stereoscopic image generating module 60, the touch sensing module 70 of this embodiment is able to function as a force sensor. That is to say, the touch input of the touch sensing module 70 of this embodiment may be executed by a conductor e.g. the finger 77 of the user, and by a non-conductor. When executing touch input with the finger 77, a coupling capacitance C_{F} will form between the finger 77 and the first sensing pad 71P and/or the second sensing pad 72P corresponding to the input point, and thus the coordinates of the input point can be determined. When executing touch input with non-conductor, the elastic medium layer 76 corresponding to the input point will be deformed by pressing, which would change the gap between the first sensing pad 71P and the common electrode 65 and the gap between the second sensing pad 72P and the common electrode 65. Consequently, a coupling capacitance Cs is formed between the first sensing pad 71P and the common electrode 65 and between the second sensing pad 72P and the common electrode 65, and thus the coordinates of the input point can be determined. In this embodiment, one substrate and one optical adhesive are omitted in fabrication of the switchable touch stereoscopic image device 100, which can reduce thickness and improve transmission rate of the switchable touch stereoscopic image device 100.

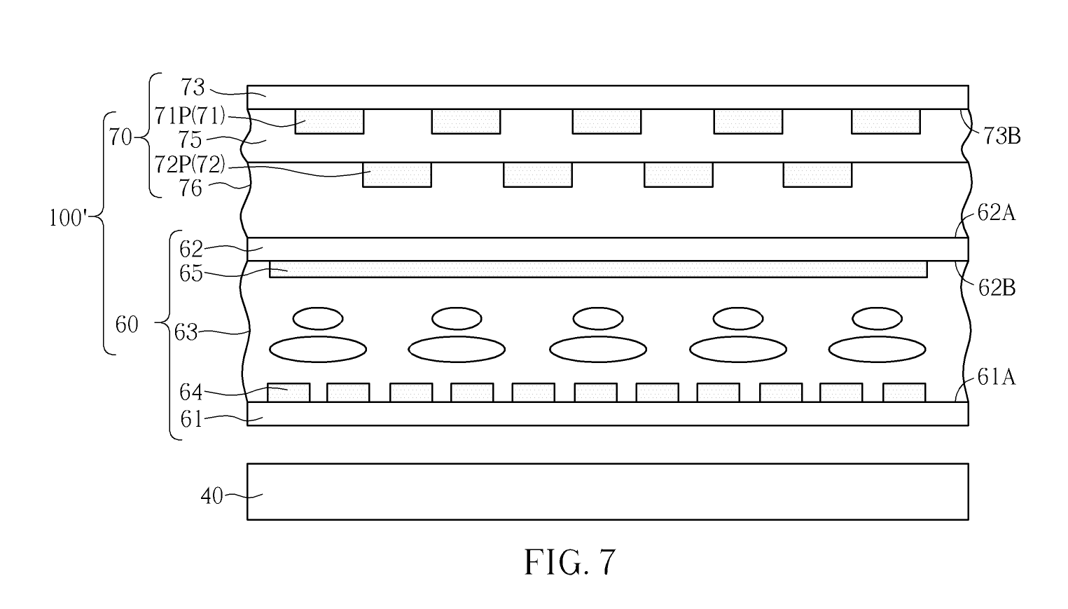

Please refer to FIG. 7. FIG. 7 is a schematic diagram illustrating a switchable touch stereoscopic image device according to a variant embodiment of the fourth preferred embodiment of the present invention. As shown in FIG. 7, different from the fourth preferred embodiment, in this variant embodiment, the first sensing pads 71P and the second sensing pads 72P of the touch sensing module 70 of the switchable touch stereoscopic image device 100′ are disposed incoplanarly. For example, the first sensing pads 71P and the second sensing pads 72P may be different conductive patterns, and the second sensing pads 72P may be disposed underneath the first sensing pads 71P, and insulated by an insulating layer 75 disposed therebetween.

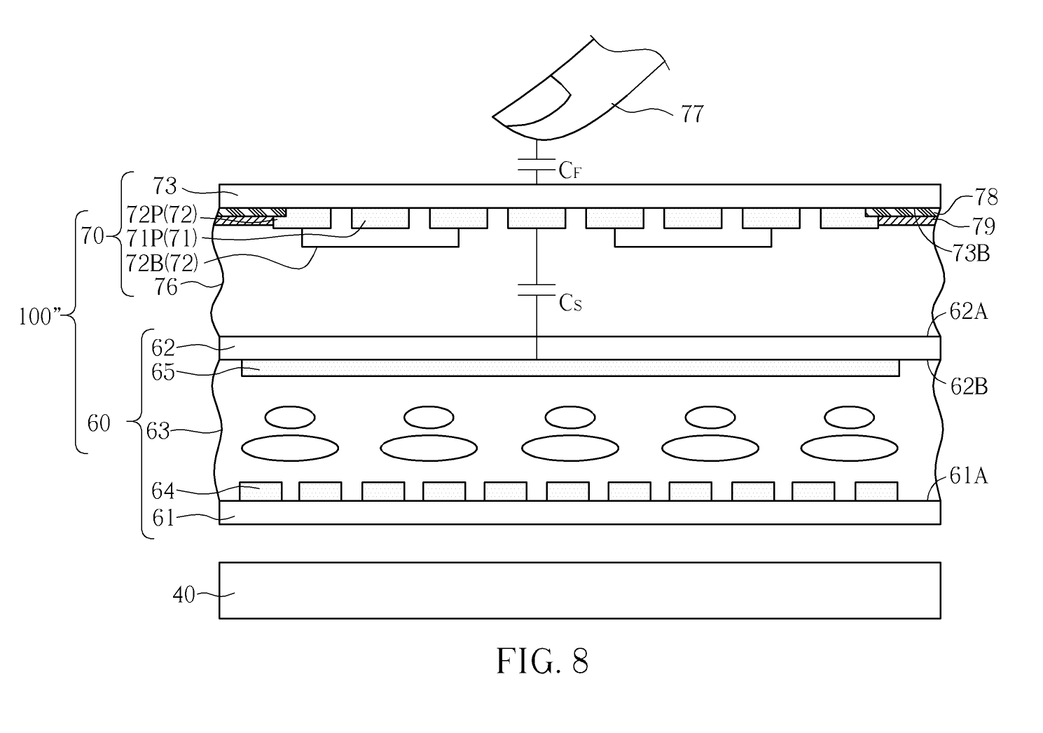

Please refer to FIG. 8. FIG. 8 is a schematic diagram illustrating a switchable touch stereoscopic image device according to another variant embodiment of the fourth preferred embodiment of the present invention. As shown in FIG. 8, different from the fourth preferred embodiment, in this variant embodiment, the touch sensing module 70 of the switchable touch stereoscopic image device 100″ may further include a decoration layer 78 disposed peripherally on the bottom surface 73B of the third substrate 73. The decoration layer 78 is light-shielding. Thus, when the first sensing electrode 71 and the second sensing electrode 72 are electrically connected to a flexible printed circuit (FPC) through metal wirings 79, the decoration layer 78 is able to shield the metal wirings 79.

It is appreciated that in the aforementioned embodiments, the first sensing electrode and the second sensing electrode are exemplarily illustrated, but not limited thereto. The sensing electrodes of the present invention may also be single-layered sensing electrodes in any forms e.g. single-layered sensing electrodes formed by a plurality of sensing electrodes having a triangle shape (as shown in FIG. 10) or by a plurality of sensing electrodes having a rectangle shape (as shown in FIG. 11). Also, the sensing electrodes may be the same conductive pattern or different conductive patterns.

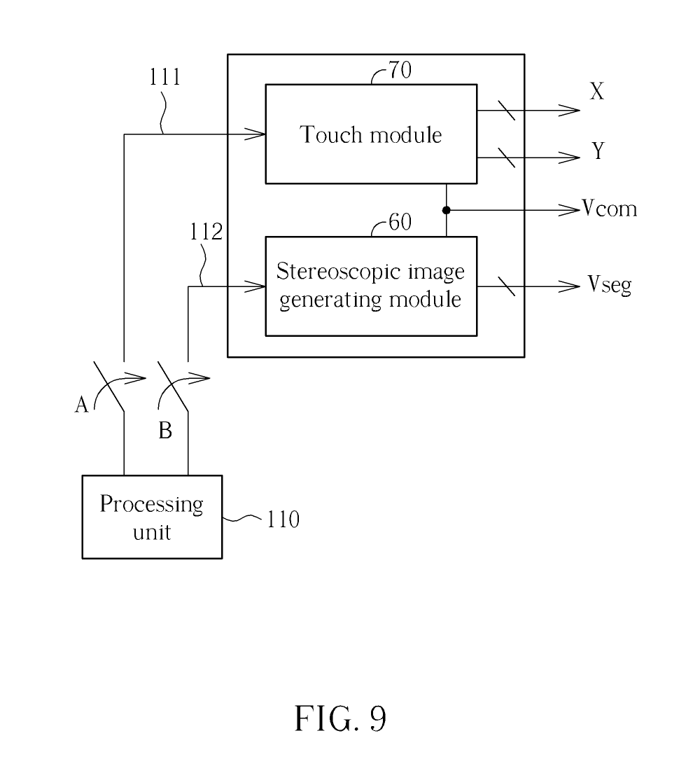

Please refer to FIG. 9 and Table 1. FIG. 9 is block diagram of the switchable touch stereoscopic image device of the present invention. Table 1 is a truth table of the switchable touch stereoscopic image device of the present invention.

TABLE 1

| control | control | touch driving | liquid crystal driving |
|---|---|---|---|
| signal A | signal B | signals X,Y | voltage V_{SEG} |
| 0 | 0 | Disable | disable |
| 0 | 1 | Disable | enable |
| 1 | 0 | Enable | disable |
| 1 | 1 | Enable | enable |

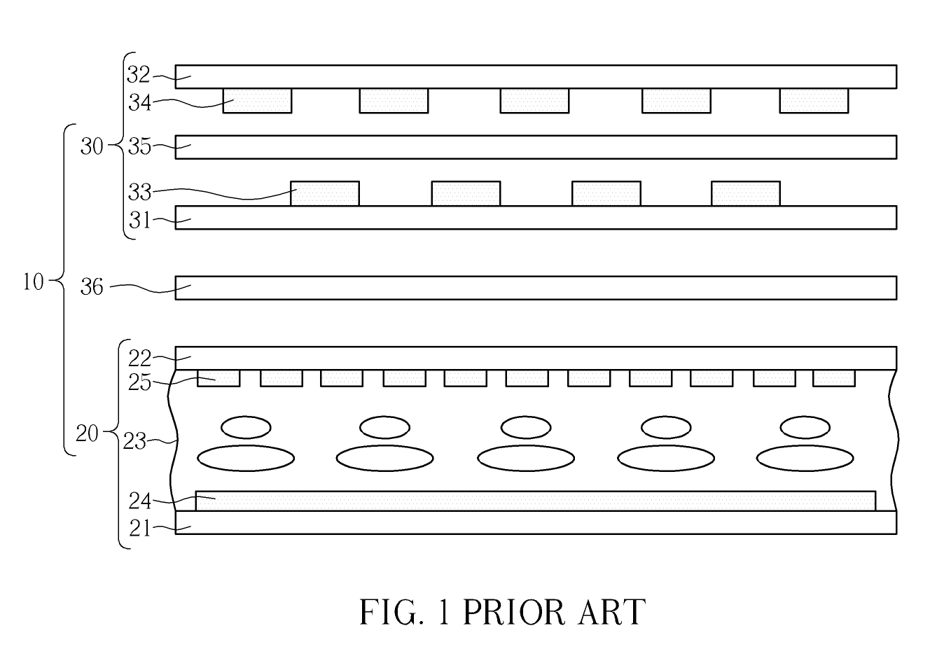

As shown in FIG. 1 and Table 1, the switchable touch stereoscopic image device may be electrically connected to a processing unit 110. The touch sensing module 70 is electrically connected to the processing unit 110 through a control wire 111, and the processing unit 110 can send a control signal A to the touch sensing module 70. The stereoscopic image generating module 60 is electrically connected to the processing unit 110 through a control wire 112, and the processing unit 110 can send a control signal B to the stereoscopic image generating module 60. When control signal A=0 and control signal B=0, the touch sensing module 70 and the stereoscopic image generating module 60 are disable. When control signal A=0 and control signal B=1, the touch sensing module 70 is disable and the stereoscopic image generating module 60 is enable, and the stereoscopic image generating module 60 will send a liquid crystal driving voltage V_{SEG} to the driving electrode and a common voltage Vcom to the common electrode. When control signal A=1 and control signal B=0, the touch sensing module 70 is enable and the stereoscopic image generating module 60 is disable, and the touch sensing module 70 will send touch driving signals X, Y to the first sensing electrode and the second sensing electrode. When control signal A=1 and control signal B=1, the touch sensing module 70 and the stereoscopic image generating module 60 are enable; the stereoscopic image generating module 60 will send a liquid crystal driving voltage V_{SEG} to the driving electrode and a common voltage Vcom to the common electrode, and the touch sensing module 70 will send touch driving signals X, Y to the first sensing electrode and the second sensing electrode. It is noted that if the touch sensing module 70 is a force sensor as illustrated in the fourth preferred embodiment, when the touch sensing module 70 is enable, the touch sensing module 70 will send a common voltage Vcom to the common electrode.

In order to avoid permanent polarization of liquid crystal molecules, the stereoscopic image generating module 60 may be driven by polarity inversion method, i.e. the polarity of the liquid crystal driving voltage Vseg is inversed after the left eye image and the right eye image are displayed in every frame. For example, the required voltage difference between the liquid crystal driving voltage Vseg and the common voltage Vcom for displaying the left eye image is assumed to be 6 volts, and the required voltage difference between the liquid crystal driving voltage Vseg and the common voltage Vcom for displaying the right eye image is assumed to be 0 volt. In such a case, the common voltage Vcom may be maintained at 0 volt in every frame time of the left eye image and the right eye image; the liquid crystal driving voltage Vseg may be set at 6 volts in the frame time of one left eye image, while the liquid crystal driving voltage Vseg may be set at −6 volts in the frame time of next left eye image.

In conclusion, the touch sensing module and the stereoscopic image generating module of the switchable touch stereoscopic image device are integratedly fabricated, and thus thickness of the switchable touch stereoscopic image device can be reduced while transmission rate of the switchable touch stereoscopic image device can be increased. In addition, the touch sensing module and the stereoscopic image generating module can operate independently for selectively providing 2D or 3D display images, and providing touch input function or not. Furthermore, the common electrode of the stereoscopic image generating module can provide shielding effect to avoid signal interference, and serve as the sensing electrode of the force sensor. Also, permanent polarization of liquid crystal molecules can be avoided by using polarity inversion driving method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A switchable touch stereoscopic image device, comprising:
a stereoscopic image generating module, comprising:
a first substrate having a top surface;
a second substrate, disposed corresponding to the first substrate, wherein the second substrate has a top surface and a bottom surface facing the top surface of the first substrate;
a plurality of driving electrodes, disposed on the top surface of the first substrate; and
a common electrode, disposed on the bottom surface of the second substrate;
a light-path converting layer, disposed between the first substrate and the second substrate; and
a touch sensing module, disposed on a side of the second substrate of the stereoscopic image generating module, wherein the touch sensing module comprises a plurality of sensing electrodes disposed on a side of the top surface of the second substrate.

2. The switchable touch stereoscopic image device of claim 1, wherein the touch sensing module further comprises a third substrate facing the second substrate, the third substrate has a bottom surface facing the top surface of the second substrate, the sensing electrodes comprises a first sensing electrode disposed on the top surface of the second substrate, and a second sensing electrode disposed on the bottom surface of the third substrate, the first sensing electrode comprises a plurality of first sensing pads, and the second sensing electrode comprises a plurality of second sensing pads.

3. The switchable touch stereoscopic image device of claim 1, wherein the sensing electrodes comprises a first sensing electrode disposed on the top surface of the second substrate, and a second sensing electrode disposed on the top surface of the second substrate, the first sensing electrode comprises a plurality of first sensing pads, and the second sensing electrode comprises a plurality of second sensing pads.

4. The switchable touch stereoscopic image device of claim 3, wherein the first sensing pads and the second sensing pads are disposed coplanarly.

5. The switchable touch stereoscopic image device of claim 3, wherein the first sensing pads and the second sensing pads are disposed incoplanarly, and the touch sensing module further comprises an insulating layer disposed between the first sensing pads and the second sensing pads.

6. The switchable touch stereoscopic image device of claim 1, wherein the touch sensing module further comprises a third substrate facing the second substrate, the third substrate has a bottom surface facing the top surface of the second substrate, the sensing electrodes comprises a first sensing electrode disposed on the top surface of the second substrate, and a second sensing electrode disposed on the bottom surface of the third substrate, the first sensing electrode is a planar electrode, and the second sensing electrode is a planar electrode.

7. A switchable touch stereoscopic image device, comprising:
a stereoscopic image generating module, comprising:
a first substrate having a top surface;
a second substrate, disposed corresponding to the first substrate, wherein the second substrate has a top surface and a bottom surface facing the top surface of the first substrate;
a plurality of driving electrodes, disposed on the top surface of the first substrate; and
a common electrode, disposed on the bottom surface of the second substrate;
a light-path converting layer, disposed between the first substrate and the second substrate; and
a touch sensing module, disposed on a side of the second substrate of the stereoscopic image generating module, the touch sensing module comprising:
a third substrate facing the second substrate, wherein the third substrate has a bottom surface facing the top surface of the second substrate;
an elastic medium layer, disposed between the second substrate and the third substrate, wherein the elastic medium layer is deformable by pressing: and
a plurality of sensing electrodes disposed on the bottom surface of the third substrate;
wherein a gap between the sensing electrodes and the common electrode is changed due to a deformation of the elastic medium layer when the third substrate is pressed.

8. The switchable touch stereoscopic image device of claim 7, wherein the sensing electrodes comprise a first sensing electrode and a second sensing electrode, the first sensing electrode and the second sensing electrode are disposed on the bottom surface of the third substrate, the first sensing electrode comprises a plurality of first sensing pads, and the second sensing electrode comprises a plurality of second sensing pads.

9. The switchable touch stereoscopic image device of claim 8, wherein the first sensing pads and the second sensing pads are disposed coplanarly.

10. The switchable touch stereoscopic image device of claim 8, wherein the first sensing pads and the second sensing pads are disposed incoplanarly, and the touch sensing module further comprises an insulating layer disposed between the first sensing pads and the second sensing pads.

11. The switchable touch stereoscopic image device of claim 8, wherein the touch sensing module further comprises a decoration layer disposed peripherally on the bottom surface of the third substrate.
